(19) United States
(12) Patent Application Publication
(10) Pub. No.: US 2014/0032270 A1
(43) Pub. Date: Jan. 30, 2014

(54) METHOD AND SYSTEM FOR PREDICTING CONSUMER SPENDING

(71) Applicants: Teik Tung, Danbury, CT (US); Heather Kowalczyk, Oakland, NJ (US)

(72) Inventors: Teik Tung, Danbury, CT (US); Heather Kowalczyk, Oakland, NJ (US)

(73) Assignee: MASTERCARD INTERNATIONAL, INC., Purchase, NY (US)

(21) Appl. No.: 13/556,853

(22) Filed: Jul. 24, 2012

(51) Int. Cl. G06Q 10/00

(52) U.S. Cl. 705/7.32

(57) ABSTRACT

A method and system for predicting consumer spending includes conducting a survey of a panel of individuals to obtain future anticipated spending data for a time periods; and tracking actual spending of the surveyed individuals for the time periods and tabulating. The method also includes calculating with a processor the difference in actual spending and the anticipated spending in the time periods to obtain spending normalization factors. The method further includes calculating the transitional probability of future spending for a time period beyond the surveyed time period to order obtain a preliminary spending prediction based on the survey results of the surveyed time periods. A prediction of consumer spending is determined by adjusting the preliminary spending prediction in response to the first and second normalization factor to determine a prediction of consumer spending for a future time period.

The present invention relates to a system for predicting spending and, more particularly, to a system and method for predicting consumer spending.

Knowledge of consumer spending is very important piece of information for businesses. Knowing how much consumers are spending and in what retail category and when spending occurs enables business to allocate their marketing resources to gain greater market share. Such information allows businesses to determine which goods or services are gaining fraction in the marketplace and how a market is developing.

Based on such information, it is desirable to predict or forecast future consumer spending so that marketing efforts, manufacturing activities and inventories can be controlled to maximize efficiency. Accordingly, it is very desirable to try and accurately forecast consumer spending for different segments of the market. Attempts to predict consumer spending are known in the art. Such predictions are largely based on historical spending patterns and economic data such as the consumer confidence index.

However, each of the methods of consumer spending forecasting is hampered by the limited information relied upon. Businesses typically only have data relating to the various segments of the market based on the sales they have made. Accurate and meaningful data for a market segment as a whole is difficult to obtain. Even if such information is obtained it only reflects what has happened in the past. While year to year trends can be established, and other historical factors can be considered to generate a prediction, the accuracy of such forecasts is limited. They are particularly limited when trying to accurately forecast spending for particular market segments or particular consumer groups.

Accordingly, it would be desirable to provide a method and system for accurately predicting consumer spending which takes into account past consumer actual spending in addition to consumer surveys.

### SUMMARY

The present invention provides a method of predicting consumer spending including:
conducting a survey of a panel of individuals to obtain future anticipated spending data for a first time period and tabulating and storing anticipated spending data in memory;
tracking actual spending of the surveyed individuals for the first time period and tabulating and storing the actual spending data in memory;
calculating with a processor the difference in actual spending and the anticipated spending in the first time period to obtain a first spending normalization factor and saving the first spending normalization factor in memory;
conducting a survey of individuals to obtain future anticipated spending data for a second time period and tabulating and storing anticipated spending results data in memory;
tracking actual spending data of the individuals for the second time period and tabulating and storing the actual spending data in memory;
calculating with a processor the difference in actual spending and the anticipated spending in the second time period to obtain a second spending normalization factor and saving the second spending normalization factor in memory;
calculating the transitional probability of future spending for a time period beyond the surveyed time period to order obtain a preliminary spending prediction based on the survey results of the first and second time periods; and
determining the prediction of consumer spending by adjusting the preliminary spending prediction in response to the first and second normalization factor to determine a prediction of consumer spending for a future time period subsequent to the second time period.

The present invention also provides a method of predicting consumer spending including:
conducting a survey of a panel of individuals to obtain future anticipated spending data for a plurality of time periods and storing anticipated spending data in memory;
tracking actual spending data of the surveyed individuals for the plurality of time periods and storing the actual spending data in memory;
calculating with a processor a transitional probability of future spending for a time period subsequent to the plurality of surveyed time periods to obtain a preliminary spending prediction based on the survey results of the first and second time periods;
calculating with the processor the difference in actual spending and the anticipated spending for each of the plurality of survey time periods obtain a spending normalization factor for each of the plurality of time periods and saving the spending normalization factors in memory; and
adjusting the preliminary spending prediction in response to the calculated normalization factors to determine a prediction of consumer spending for a future time period subsequent to plurality of survey time periods.

The present invention further provides a system for predicting consumer spending including a processor configured to receive survey results of a panel of individuals relating to future anticipated spending for a first time period and tabulating and storing anticipated spending results data in memory;
the processor in communication with a payment transaction database, and the processor tracking actual spending data of the group of surveyed individuals for the first time period and tabulating and storing actual spending data in memory;
the processor calculating the difference in actual spending and the anticipated spending in the first time period to obtain a first spending normalization factor and saving the first spending normalization factor in memory;
the processor being configured to receive survey results of the group of individuals relating to future anticipated spending for a second time period and tabulating and storing anticipated spending results data in memory;
the processor tracking actual spending of the group surveyed individuals for the second time period and tabulating and storing the actual spending data in memory;
the processor calculating the difference in actual spending and the anticipated spending in the second time period to obtain a second spending normalization factor and saving the second spending normalization factor in memory; and
the processor determining a preliminary spending forecast based on the survey results and adjusting the preliminary spending forecast in response to the first and second normalization factors to determine a prediction of consumer spending for a future time period subsequent to the second time period.

### BRIEF DESCRIPTION OF THE DRAWINGS

FIG. 1 is a flow diagram of the process of the present invention.

FIG. 2 is a block diagram of a system for predicting consumer spending.

### DETAILED DESCRIPTION OF THE INVENTION

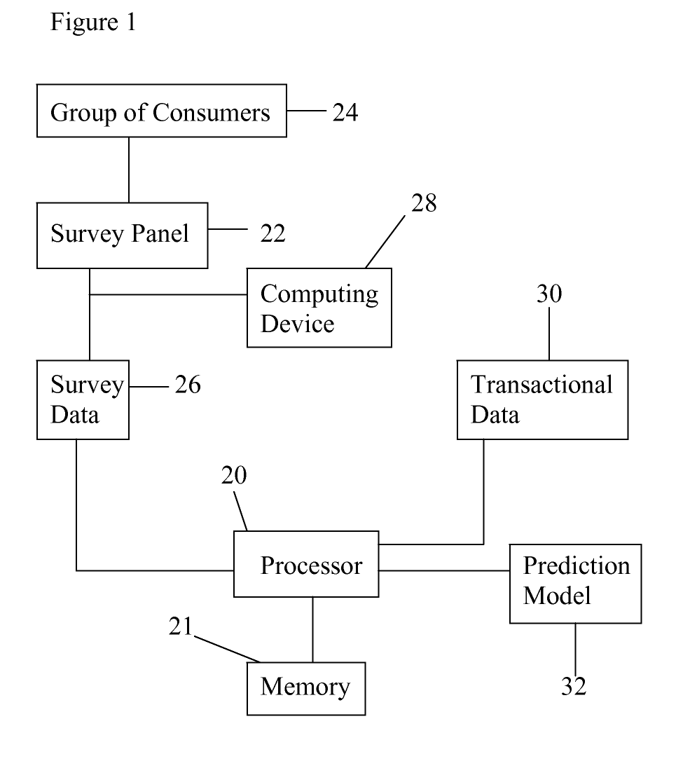

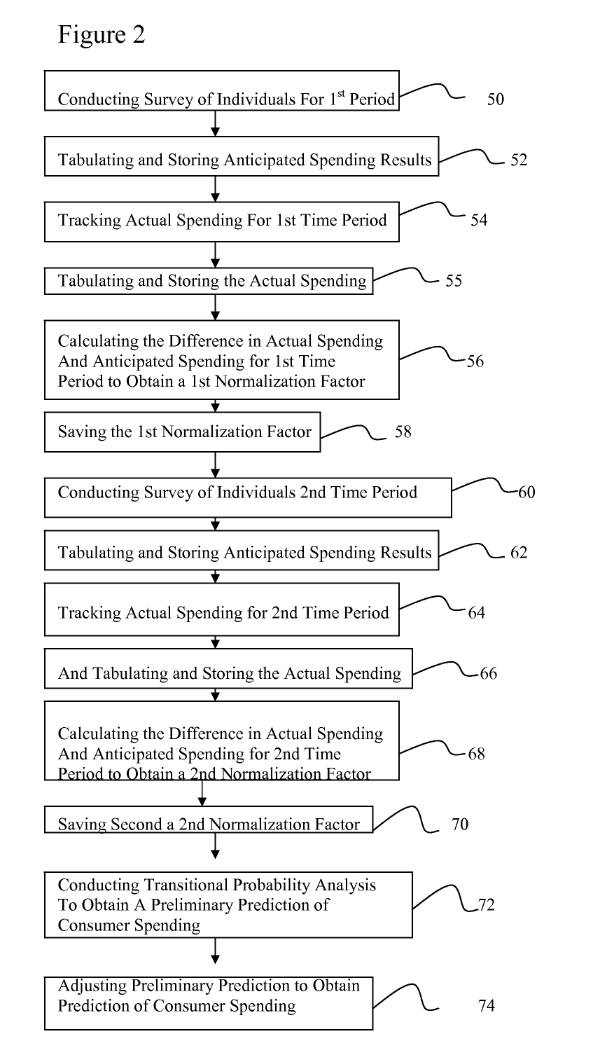

With reference to FIGS. 1 and 2, the present invention provides a system and method of accurately predicting or forecasting consumer spending. Such forecasts can be targeted to particular market segments and/or geographical locations to provide additional insight into future spending habits.

The consumer spending forecast may be generated using two basic types of prediction data: 1) consumer survey data which includes the responses from consumers as to the type of spending they intend to carry out over a particular time period and 2) actual spending data for that particular time period.

In order to generate the spending forecast the data may be processed by a processor 20 including or operable connected to memory 21. The processor may include software and hardware such as a computing device having a central processing unit and memory.

With reference to FIG. 1, in order to generate the consumer survey data, a panel of consumers 22 may be selected. The panel 22 may be drawn from a large group 24 of pre-recruited consumers who have agreed to participate in surveys regarding spending habits and related matters. This large group may have a demographic composition that is representative of a population, e.g., United States population, in terms of age, gender, income, and geographic distribution. From this group, panel members may be selected to participate in a survey based on various demographic criteria, including age, gender, income level, prior spending habits, lifestyle and/or life stages.

One lifestyle segment may be those who have a high income and spend freely. Another group may be those with a high income who spend more conservatively. Another life style group may be those who live paycheck-to-paycheck. Life stages may include singles, married couples just starting out, married with children, those approaching retirement and retirees.

This panel once established may be given a survey including questions inquiring as to such areas as:
their financial products ownership
the way they pay for their purchases using credit, debit, cash, checks, store cards and prepaid cards
names of the credit and debit cards owned,
cardholder satisfaction, consumer attitudes and preferences
spending in all the major merchant categories
consumer economic sentiment

This survey data is tabulated by the processor and saved in a survey database 26.

Surveys may be conducted throughout the course of the year to selected groups of panelists or to the overall panel to collect consumer insights and sentiment. The panel may be made up of consumers who use an electronic payment device such as a credit or debit card such that the transaction data can be tracked. The survey may be administered on a web based application with respondents being able to access the survey and submit responses from a remote computing device 28, such as a home computer or mobile smartphone. Alternatively, surveys could be conducted in writing or over the phone.

Based on these surveys, information as to what consumers expect to be spending over a certain time period is collected. For example, the period may be 3 months although it could be shorter or longer as desired. This information can be organized by the any of the characteristics of the survey respondents, for example, income level, gender, age, geographical regions and/or life stage or life style. Spending in a particular market segment, e.g., housewares, clothing, or electronic goods may be surveyed.

The survey data can be operated upon by the processor 20 to generate a preliminary prediction of consumer spending. This preliminary prediction can be obtained by using transactional probability analysis based on the survey results an constructing a stochastic model. The stochastic model be constructed by conducting transitional probability analysis using Markov chains of consumer spending patterns changing from one time period to the next, n and n+1, for example from time period 1 to period 2 and so on. The Markov process employed may be of a type well known in the art. Such a process is described in Topics of Management Science, 2ed. Robert E. Markland Chap. 14, which is incorporated by reference herein. The transitional probability may be calculated for a time period 2 to 3, a time period 3 to 4 and so one. By using the Markov chain a transitional probability can be forecast for time periods extending beyond the survey data periods. For example, if survey results for time period 1 though 6 are run through the Markov process, a probability of consumer spending for time period 7 to 8 and subsequent time periods can be predicted. However, while the transitional probability alone provides a means of predicting future spending it is limited in its accuracy. In the present invention, the transitional probability provides a preliminary prediction of consumer spending.

While consumer surveys can be used to provide the preliminary prediction, this information alone provides forecasts having a large margin for error. The accuracy of spending forecasts is significantly improved when the survey results are supplemented by actual transaction data in accordance with the present invention.

Accordingly, the second type of data which is used to generate the spending predictions is actual transaction data. This data may be collected in a financial transaction database or data warehouse 30. The data may be generated from the records of all credit, debit and prepaid card transactions that move through a payment system such as the MasterCard® payment system. The transaction data captured in the warehouse may include the dollar amount of the transaction, date and time, merchant name and location data, e.g., zip code. The transaction data can also include the payment means such as credit card, debit card, or checks.

In order to increase the accuracy of the forecasts, the customers who are surveyed are linked to the transactional data 30 by the processor 20. Certain predetermined transaction details of spending receipts from surveyed consumers may be used for forecasting spending. These details may include transaction dollar amount, date and time and merchant zip code. This data may then be matched with the survey responses. By matching the survey respondent provided receipt data fields against the transaction data fields, a link between the survey panel database and the transaction database is established. Therefore, the panelists' transactions in the database can be analyzed and surveys can be generated and sent to the panelists in order to obtain their feedback and spending sentiment.

The survey information and actual transaction data may then be processed in order to generate a reliable prediction model 32 as to consumer spending. In a preferred embodiment, a panel of consumers is surveyed about their anticipated spending in a particular time period, e.g., period 1. This time period could be based on a predetermined number of days, e.g., the next month, or could be linked to a season or holiday. The survey results are received from a group of respondents and tabulated by a processor and stored in a database. The actual spending of this same group of consumers is tracked over the same time period, i.e., time period 1, and this data is tabulated and stored.

The transaction data may be linked to a particular group of survey respondents and not to an individual. For example, the transaction data from all survey respondents in a certain demographic category such as males having incomes between $100,000 and $200,000 living in the Northeast, is collected and linked to the same demographic category of survey respondents. The payment transactions of an individual are not reviewed, instead the payments transactions of the group in the aggregate are used to compare with the survey responses. In this way an individual's particular spending habits are not scrutinized and the anonymity of the consumer is maintained.

In order to enhance the accuracy of the preliminary prediction of consumer spending this predictive value is adjusted by a normalization factor to determine a prediction of consumer spending. The normalization factor is the delta between the surveyed spending results and the actual spending for the given time period. In order to determine the normalization factor, the spending forecast of the survey respondents for time period 1 is compared to their actual spending for the time period 1. The normalization factor for each time period can be calculated. The actual spending may be obtained from the database of payment transactions such as the MasterCard® transactional data warehouse.

The processor 20 then computes the difference between actual spending versus forecasted surveyed spending. These differences can be compared based on various parameters including income groups, merchant categories and census regions. For example, the data can be compared to determine the difference, or delta, between forecasted spending and actual spending based on income groups. It may be found that the delta between forecasted spending and actual spending may vary based on income level. Likewise, it may be found that the delta between forecast and actual spending may vary by geographical region. The tracking of survey responses and actual spending may be repeated over several time periods to assess impact of seasonality on spending. The actual spending is determined from a large database of actual payment transactions; therefore, a wide spectrum of commerce is reflected.

A predictive model 32 is created to determine a prediction of consumer spending. The predictive model includes applying the calculated normalization factor to the preliminary spending prediction determined through the transaction probability analysis. The normalization factor allows the accuracy of the spending forecast to be increased. For example, if the transactional probability based on the survey results predicts that in time period n to n+1 that a particular demographic of respondents would spend $200 dollars in clothing, but the normalization factor shows that this demographic tends to underestimate its spending on clothing by 10%, the predictive model would adjust the transactional probability of $200 to $220.

As conditions change, such as the state of the economy, weather, holidays, etc., the normalization factor may change. For example during the holidays, consumers may tend to spend more than they report on a survey than during other times of the year. Therefore, the normalization factor may be periodically recalculated and refined.

With reference to FIG. 2, a consumer spending forecast or prediction may be generated in accordance with the present disclosure by conducting a survey of preselected panel of individuals to obtain future anticipated spending for a first time period 50. These individuals may be selected from a group of potential consumers based on various demographic criteria. The survey of anticipated spending may be conducted online with panel members providing their responses on a home computer or other computing device. The responses are tabulated and the survey data is stored results in memory such as a database 52. The tabulation may be conducted by the processor 20. The actual spending of the surveyed individuals is then tracked for the first time period 54 and tabulated and stored the in memory 55. The difference in actual spending and the anticipated spending is calculated with a processor in the first time period to obtain a first normalization factor 56. The first normalization factor is then saved in memory 58.

A survey of the panel to obtain future anticipated spending for a second time period is conducted 60 with the anticipated spending results being tabulated and stored in memory 62. The actual spending data of the individuals is tracked for the second time period 64 and the actual spending information is tabulated and stored in memory 66. The processor calculates the difference in actual spending and the anticipated spending in the second time period to obtain a second normalization factor 68. The second normalization factor is saved in memory 70.

A stochastic model is constructed by conducting transitional probability analysis using Markov chains of consumer spending patterns changing from the first period, n, to the second period, n+1. A preliminary prediction of consumer spending is generated using the transitional probability analysis. 72

The preliminary spending prediction is adjusted in response to the first and second normalization factor to determine a prediction of consumer spending for the time period n to n+1, 74. The normalization factors for the different time periods may be averaged and the averaged normalization factor may be used to adjust the preliminary spending prediction. A seasonalized normalization factor may also be employed. For example, the normalization factor used in the first quarter Q1 of the prior year may be used for the first quarter of the subsequent year.

This same process may be repeated over numerous time periods in order to fine tune the transitional probability preliminary prediction and the normalization factor, which allows for more robust and accurate spending predictions.

As set forth above, a survey panel can be selected based on certain predetermined characteristics. By constructing the panel of surveyed individuals to have certain characteristics, nominalization factors for different categories of consumers may be obtained. For example, it may be that survey panels having a high income may tend to over predict how much they intend to spend on electronic goods. Those of lower income levels may under predict such spending. Therefore, these groups would have different nominalization factors. Applying the correct normalization factor to the particular group of survey respondents leads to increased accuracy of consumer spending forecasts.

It will be appreciated that the present invention has been described herein with reference to certain preferred or exemplary embodiments. The preferred or exemplary embodiments described herein may be modified, changed, added to or deviated from without departing from the intent, spirit and scope of the present invention, and it is intended that all such additions, modifications, amendments and/or deviations be included in the scope of the present invention.

1. A method of predicting consumer spending comprising:
conducting a survey of a panel of individuals to obtain future anticipated spending data for a first time period and tabulating and storing the anticipated spending data in memory;
tracking actual spending data of the surveyed individuals for the first time period and tabulating and storing the actual spending data in memory;
calculating with a processor the difference in the actual spending and the future anticipated spending in the first time period to obtain a first spending normalization factor and saving the first spending normalization factor in memory;
conducting a survey of individuals to obtain future anticipated spending data for a second time period and tabulating and storing anticipated spending results data in memory;
tracking actual spending data of the individuals for the second time period and tabulating and storing the actual spending data in memory;
calculating with a processor the difference in actual spending and the future anticipated spending in the second time period to obtain a second spending normalization factor and saving the second spending normalization factor in memory;
calculating a transitional probability of future spending for a time period beyond the surveyed time period to obtain a preliminary future spending prediction based on the survey results of the first and second time periods; and
determining a prediction of consumer spending by adjusting the preliminary spending prediction in response to the first and second normalization factors to determine a prediction of consumer spending for a future time period subsequent to the second time period.

2. The method as defined in claim 1, wherein calculating the transitional probability of future spending includes using Markov chains of consumer spending patterns changing from the first time period to the second time period.

3. The method as defined in claim 1, wherein the surveyed panel of individuals is chosen based on predetermined characteristics.

4. The method as defined in claim 3, wherein the surveyed panel of individuals is selected based on lifestyle categories based on spending habits.

5. The method as defined in claim 3, wherein the surveyed panel of individuals is selected based on life stage categories selected from the group consisting of singles, married couples, married with children, individuals approaching retirement, and retirees.

6. The method as defined in claim 1, wherein the transaction data is linked to a particular panel of surveyed respondents.

7. The method as defined in claim 1, wherein the processor is configured to use a stochastic model using Markov chains to determine the transitional probability of future spending.

8. The method as defined in claim 1, wherein the first time period has the same duration as the second time period.

9. The method as defined in claim 1, wherein the first time period is in the range of 2 to 4 months.

10. The method as defined in claim 1, wherein the surveying and tracking steps are repeated for additional time periods.

11. A method of predicting consumer spending comprising:
conducting a survey of a panel of individuals to obtain future anticipated spending data for a plurality of time periods and storing the anticipated spending data in memory;
tracking actual spending data of the surveyed individuals for the plurality of time periods and storing the actual spending data in memory;
calculating with a processor a transitional probability of future spending for a time period subsequent to the plurality of surveyed time periods to obtain a preliminary future spending prediction based on the survey results of a first and a second time period;
calculating with the processor the difference in actual spending and the anticipated future spending for each of the plurality of survey time periods obtain a spending normalization factor for each of the plurality of time periods and saving the spending normalization factors in memory; and
adjusting the preliminary spending prediction in response to the calculated normalization factors to determine a prediction of consumer spending for a future time period subsequent to plurality of survey time periods.

12. The method as defined in claim 11, wherein calculating the transitional probability of future spending includes using Markov chains of consumer spending patterns changing from the first time period to the second time period.

13. The method as defined in claim 11, wherein the surveyed individuals are chosen based on predetermined characteristics.

14. The method as defined in claim 13, wherein the surveyed individuals may be selected based on lifestyle.

15. The method as defined in claim 11, wherein the spending data is linked to a particular panel of surveyed respondents.

16. A system for predicting consumer spending comprising:
a processor configured to receive survey results of a panel of individuals relating to future anticipated spending for a first time period and tabulating and storing anticipated spending results data in memory;
the processor in communication with a payment transaction database, and the processor tracking actual spending data of a group of surveyed individuals for the first time period and tabulating and storing actual spending data in memory;
the processor calculating the difference in actual spending and the anticipated future spending in the first time period to obtain a first spending normalization factor and saving the first spending normalization factor in memory;
the processor being configured to receive survey results of the group of surveyed individuals relating to future anticipated spending for a second time period and tabulating and storing anticipated spending results data in memory;
the processor tracking actual spending of the group of surveyed individuals for the second time period and tabulating and storing the actual spending data in memory;
the processor calculating the difference in actual spending and the anticipated future spending in the second time period to obtain a second spending normalization factor and saving the second spending normalization factor in memory; and
the processor determining a preliminary spending forecast based on the survey results and adjusting the preliminary spending forecast in response to the first and second normalization factors to determine a prediction of consumer spending for a future time period subsequent to the second time period.

17. The system as defined in claim 16, wherein the determining of the preliminary spending forecast includes conducting transitional probability analysis of consumer spending patterns changing from the first period to the second period.

18. The system as defined in claim 16, wherein a panel of survey respondents are selected based on factors selected from the group consisting of income group, lifestyle, life stages, census regions, and age.

19. The system as defined in claim 16, wherein the first time period has the same duration as the second time period.

20. The system as defined in claim 16, wherein the first time period is in the range of about 2 to 4 months.

21. The system as defined in claim 16, wherein the processor analyzes group survey spending data and group actual spending data for additional time periods.
